(19) United States
(12) Patent Application Publication
(10) Pub. No.: US 2006/0103975 A1
(43) Pub. Date: May 18, 2006

(54) Disk driving apparatus and magnetic disk apparatus having the same

(75) Inventors: Takahiro Tokumiya, Yokohama-si (JP); Keiichiro Yoshida, Yokohama-si (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/265,253

(22) Filed: Nov. 3, 2005

(30) Foreign Application Priority Data
Nov. 12, 2004 (JP) 2004-329048
Apr. 6, 2005 (KR) 10-2005-0028545

(51) Int. Cl. G11B 17/02

(52) U.S. Cl. 360/99.12

(57) ABSTRACT

A disk driving apparatus includes a bearing sleeve having a cylindrical shape, a shaft rotatably supported in the bearing sleeve, a hub coupled to the shaft and having a support portion which supports a disk medium outside of the bearing sleeve, the hub further having a male screw portion formed on an outer circumferential surface of an upper end portion thereof, a clamp having a hole formed at the center thereof, in which the upper end portion of the hub is inserted, and which clamps the disk medium with the support portion of the hub, and a nut screw-coupled to the male screw portion of the hub and which provides a clamping force of the clamp.

### CROSS-REFERENCE TO RELATED PATENT APPLICATIONS

This application claims priority from Korean Patent Application No. 10-2005-0028545, filed on Apr. 6, 2005, in the Korean Intellectual Property Office and Japanese Patent Application No. 2004-329048, filed on Nov. 12, 2004, in the Japanese Patent Office, the disclosures of which are incorporated herein in their entirety by reference.

### BACKGROUND OF THE INVENTION

1. Field of the Invention

The present invention relates to a magnetic disk apparatus and, more particularly, to a disk driving apparatus for supporting a disk medium and rotating the disk medium at a particular speed, and a disk apparatus having the same.

2. Description of the Related Art

Recently, as computers are made smaller and thinner, magnetic disk apparatuses, for example, hard disk drives, mounted in the computers, are accordingly required to be smaller and thinner. To satisfy the demand, as one method of implementing small and thin hard disk drives used for computers, a method of clamping the disk medium using a hub and a clamp has been used for a disk driving apparatus for supporting the disk medium and rotating the same at a particular speed.

FIG. 1 is a cross-sectional view of a conventional disk driving apparatus. Referring to FIG. 1, a conventional disk driving apparatus 10, which is referred to as a shaft rotating spindle motor, includes a cylinder shaped bearing sleeve 2 fixed to a base member 1 of a magnetic disk apparatus (not shown), a shaft 3 rotatably supported inside the bearing sleeve 2, a hub 4 coupled to the shaft 3, a clamp 6 clamping a disk medium 5 together with the hub 4, and a clamping screw 7 fixing the clamp 6.

The bearing sleeve 2 is inserted in the base member 1 to be fixed thereon and has a dynamic bearing portion 8 for rotatably supporting the shaft 3 at an inner circumferential surface of the bearing sleeve 2. The shaft 3 has a substantially cylindrical shape and has a small diametric portion 3a at an upper end portion thereof where the diameter of the shaft 3 is reduced. Screw holes 3b and 3f, which are female screws, are inwardly formed to predetermined depths at upper and lower surfaces of the shaft 3, respectively. A cylindrical portion 4a is formed at the center of the hub 4 and inserted around an outer circumferential surface 3c of the small diametric portion 3a to be fixed thereto. A support portion 4b protruding toward the disk medium 5 is formed at an outer circumferential edge portion of the hub 4. The clamp 6 is an elastic member having a substantially “Ω” shaped section and has a circular hole 6a formed at the center thereof. The clamping screw 7 includes a screw portion 7a and a head portion 7b, which are integrally formed, and is coupled to the upper end of the shaft 3 by interposing the clamp 6 between the hub 4 and the clamping screw 7. The clamping screw 7 fixes the clamp 6 at a predetermined position and provides an elastic force (a clamping force) to the clamp 6 so that the disk medium 5 interposed between the support portion 4b of the hub 4 and the clamp 6 to clamp the disk medium 5.

In the disk driving apparatus 10, lubrication fluid such as lubrication oil is injected in a fine gap portion between the bearing sleeve 2 and the shaft 3. The lubrication fluid, for example, is pressed by a dynamic pressure generating groove (not shown) formed concavely on a dynamic surface of the shaft 3 so that dynamic pressure is generated.

However, in the conventional disk driving apparatus 10, since the clamping screw 7 fixes the clamp 6, the height of the disk driving apparatus 10 cannot be sufficiently reduced. Thus, it is difficult to implement a thin magnetic disk apparatus.

In other words, when the overall height of the disk driving apparatus 10 is reduced by decreasing the height of the shaft 3, since the height of the dynamic bearing portion 8 having a great influence on the strength of the disk driving apparatus 10 is also reduced, there is a problem in that the shaft 3 and the disk medium 5 cannot be stably rotated. When the height of the dynamic bearing portion 8 is secured while the height of the shaft 3 is reduced, that is, when the length of the small diametric portion 3a is decreased, the coupling of the hub 4 becomes difficult. Also, as the length of the clamping screw 7 is reduced, the coupling force of the clamping screw 7 is reduced so that the clamp 6 cannot be firmly fixed.

Also, when the clamp 6 is fixed by the coupling of the clamping screw 7, the determination on a position to fix the clamp 6 at a particular position is difficult and it is difficult to firmly clamp the disk medium 5 with a predetermined clamping force. Thus, a case in which the disk medium 5 does not stably rotate may occur.

### SUMMARY OF THE INVENTION

To solve the above and/or other problems, the present invention provides a disk driving apparatus which can secure strength to obtain stable rotation while reducing the thickness thereof, and a magnetic disk apparatus having the same.

According to an aspect of the present invention, a disk driving apparatus comprises a bearing sleeve having a cylindrical shape, a shaft rotatably supported in the bearing sleeve, a hub coupled to the shaft and having a support portion which supports a disk medium outside of the bearing sleeve, said hub further having a male screw portion formed on an outer circumferential surface of an upper end portion thereof, a clamp having a hole formed at the center thereof, in which the upper end portion of the hub is inserted, and which clamps the disk medium with the support portion of the hub, and a nut screw-coupled to the male screw portion of the hub and which provides a clamping force of the clamp.

The hub comprises a step portion having a diameter greater than that of the male screw portion and formed under the male screw portion.

The hub may include a forcible insertion hole, and a protruding portion vertically protrudes from an upper surface of the shaft and is forcibly inserted into the forcible insertion hole. A screw portion is formed on each of an outer circumferential surface of the protruding portion and an inner circumferential surface of the forcible insertion hole, to be coupled with each other.

According to another aspect of the present invention, a magnetic disk apparatus including a base and a cover member, a disk medium for storing data, a disk driving apparatus installed on the base and which rotates the disk medium at a particular speed, and an actuator installed on the base to be operative to pivot and move a read/write head to a desired position on the disk medium, comprises a bearing sleeve having a cylindrical shape, a shaft rotatably supported in the bearing sleeve, a hub coupled to the shaft and having a support portion which supports a disk medium outside of the bearing sleeve, said hub further having a male screw portion formed on an outer circumferential surface of an upper end portion thereof, a clamp having a hole formed at the center thereof, in which the upper end portion of the hub is inserted, and which clamps the disk medium with the support portion of the hub, and a nut screw-coupled to the male screw portion of the hub and which provides a clamping force of the clamp.

### BRIEF DESCRIPTION OF THE DRAWINGS

The above and other features and advantages of the present invention will become more apparent by describing in detail exemplary embodiments thereof with reference to the attached drawings, in which:

FIG. 1 is a cross-sectional view of a conventional disk driving apparatus;

FIG. 2 is an exploded perspective view of a magnetic disk apparatus having a disk driving apparatus according to an exemplary embodiment of the present invention;

FIG. 3 is a cross-sectional view of the disk driving apparatus of FIG. 2; and

FIG. 4 is a cross-sectional view of a modified example of the shaft and the hub shown in FIG. 3.

### DETAILED DESCRIPTION OF ILLUSTRATIVE, NON-LIMITING EMBODIMENTS OF THE INVENTION

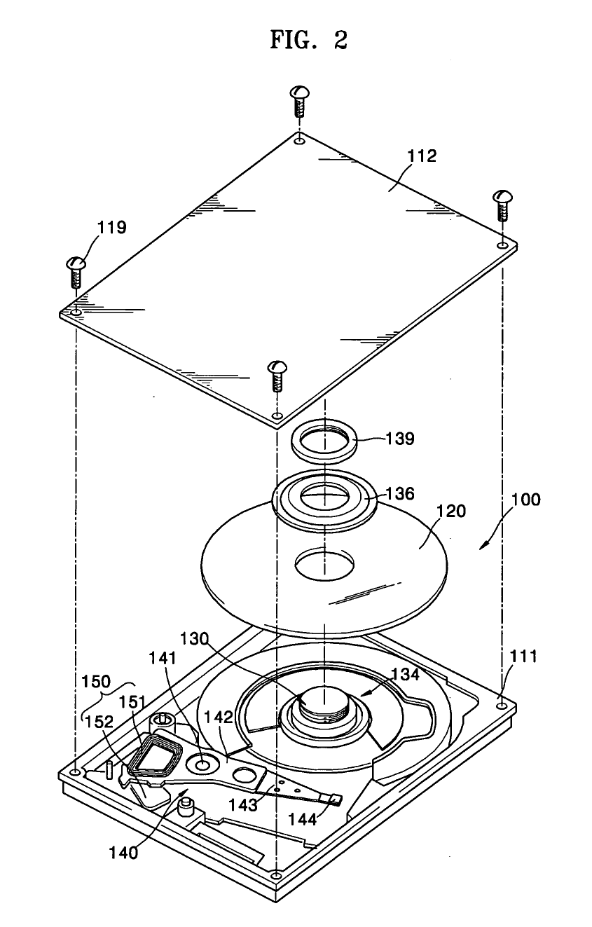

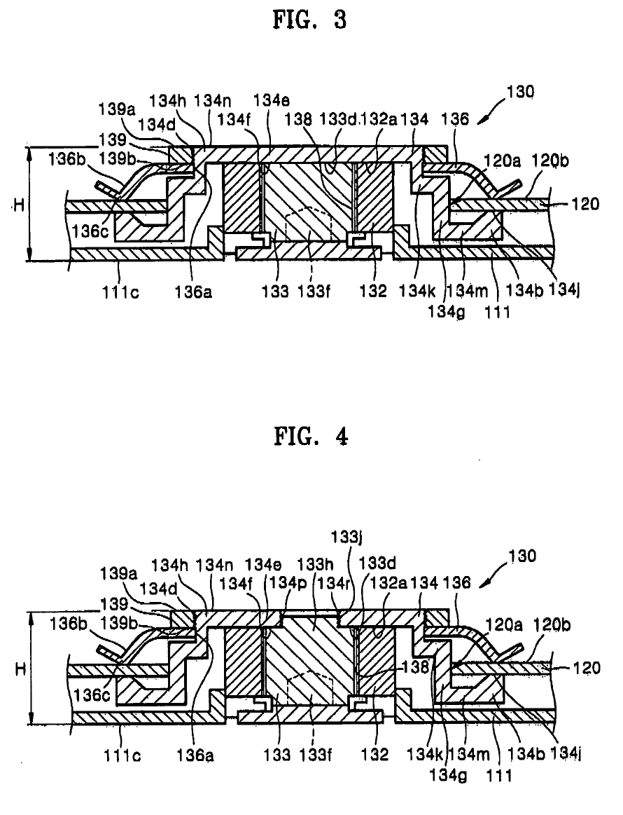

Referring to FIGS. 2 and 3, a magnetic disk apparatus 100, that is, a hard disk drive, includes a base 111 and a cover member 112 coupled to the base 111. The cover member 112 can be coupled to the base 111 by a plurality of coupling screws 119. A disk driving apparatus 130 for rotating a disk medium 120 for storing data at a particular speed while supporting the same is installed on the base 111. An actuator 140 for moving a read/write head 144 to a desired position on the disk medium 120 is installed on the base 111.

The actuator 140 includes a swing arm 142 rotatably coupled to an actuator pivot 141 installed on the base 111 and a suspension 143 installed at an end portion of the swing arm 142 and supporting the head 144 to be elastically biased toward a surface of the disk medium 120. The actuator 140 includes a voice coil motor (VCM) 150 for rotating the swing arm 142. The voice coil motor 150 includes a VCM coil 151 coupled to the other end portion of the swing arm 142 and the magnet 152 arranged to face the VCM coil 151.

The VCM 150 is controlled by a servo control system (not shown) to rotate the swing arm 142 in a direction according to the Fleming's left hand rule by the interaction between current applied to the VCM coil 151 and a magnetic field generated by the magnet 152. That is, when the power of the magnetic disk apparatus 100 is turned on and the disk medium 120 starts rotating, the VCM 150 rotates the swing arm 142 counterclockwise so that the head 144 is moved above a recording surface of the disk medium 120. In contrast, when the power of the magnetic disk apparatus 100 is turned off and the rotation of the disk medium 120 is stopped, the VCM 150 rotates the swing arm 142 clockwise so that the head 144 is moved out of the disk medium 120.

The disk driving apparatus 130 according to the present embodiment is installed on the base 111 and rotates the disk medium 120 at a particular speed. The disk driving apparatus 130 includes a cylindrical bearing sleeve 132, a shaft 133 rotatably supported in the bearing sleeve 132, a hub 134 coupled to the shaft 133, a nut 139 coupled to a male screw portion 134d formed on an outer circumferential surface of the hub 134, and a clamp 136 having a circular hole 136a for the insertion of the hub 134 formed at the center thereof and clamping the disk medium 120 with the hub 134.

The bearing sleeve 132 is supported on the base 111 and a dynamic bearing portion 138 for rotating the shaft 133 is provided at an inner circumferential surface of the bearing sleeve 132. The shaft 133 has a substantially cylindrical shape and an upper surface 133d which is horizontally flush with an upper surface 132a of the bearing sleeve 132. A screw hole 133f having a female screw in an inner surface thereof is formed in a lower portion of the shaft 133.

The hub 134 is formed of metal such as stainless steel or aluminum. The hub 13 includes a ceiling plate portion 134e making surface contact with the upper surface 133d of the shaft 133 and having a disc shape with a diameter greater than an outer diameter of the bearing sleeve 132, a side wall portion 134g extending downward toward the base 111 from an outer circumferential edge of the ceiling plate portion 134e, and an extending portion 134m horizontally extending from a lower end portion of the side wall portion 134g to increase the diameter of the hub 134.

The ceiling plate portion 134e makes surface contact with the upper surface 133d of the shaft 133 by attaching the upper surface 133d of the shaft 133 and a lower surface 134f of the ceiling plate portion 134e using an adhesive. A male screw portion 134d is formed on an outer circumferential surface of the ceiling plate portion 134e. A support portion 134b protrudes upward from the outer edge portion of the extending portion 134m. An upper surface 134j of the support portion 134b makes surface contact with the disk medium 120 to support the disk medium 120. Also, a step portion 134k having a step shape is formed at a predetermined position in about a middle portion of the side wall portion 134g, that is, under the male screw portion 134d.

The disk medium 120 is a rigid body having a disc shape and the diameter thereof may be, for example, not greater than one inch. As the side wall portion 134g of the hub 134 is inserted in a center hole 120a formed at the center of the disk medium 120, the disk medium 120 makes a surface contact with the upper surface 134j of the support portion 134b of the hub 134 and is accommodated thereon.

The nut 139 is formed of metal such as stainless steel or aluminum. The nut 139 is screw-coupled to the male screw portion 134d formed on the outer circumferential surface of the ceiling plate portion 134e of the hub 134. The nut 139 has an upper surface 139a which is installed at almost the same height as an upper surface 134n of the ceiling plate portion 134e of the hub 134 or to be lower than the upper surface 134n of the ceiling plate portion 134e.

The clamp 136 is formed of metal such as stainless steel or aluminum. The clamp 136 is an elastic member having a substantially Ω-shaped section and has a ring shape in which the circular hole 136a is formed at a center thereof. The ceiling plate portion 134e of the hub 134 and a portion of an upper end portion of the side wall portion 134g are inserted in and pass through the circular hole 136a. An upper surface 136b of the clamp 136 around the circular hole 136a closely contacts a lower surface 139b of the nut 139. A portion of an outer circumferential surface of the clamp 136 is bent upward and a bending portion 136c presses against an upper surface 120b of the disk medium 120 accommodated on the upper surface 134j of the support portion 134b.

In the above structure, the height H of the disk driving apparatus 130 from a lower surface 111c of the base 111 to the nut 139 and the upper surface 134n of the ceiling plate portion 134e of the hub 134 is about 2.7 mm or less.

In the method of clamping the disk medium 120 by the disk driving apparatus 130 configured as above, first, the bearing sleeve 132 is inserted in the base 111. The shaft 133 is inserted in the bearing sleeve 132 and the hub 134 is installed. Next, the center hole 120a of the disk medium 120 is inserted around the outer circumferential surface of the side wall portion 134g of the hub 134 so that the disk medium 120 makes surface contact with the upper surface 134j horizontally formed on the support portion 134b of the hub 134 to be accommodated thereon. Then, the clamp 136 is arranged such that the ceiling plate portion 134e of the hub 134 and the outer circumferential surface of the side wall portion 134g of the hub 134 pass through the circular hole 136a of the clamp 136. Finally, the nut 139 is coupled to the male screw portion 134d formed at the outer circumferential surface of the ceiling plate portion 134e of the hub 134. The upper surface 139a of the nut 139 should be disposed at the almost same height as the upper surface 134n of the ceiling plate portion 134e of the hub 134 or lower than that. As the nut 139 is coupled, the clamp 136 formed of an elastic member is pressed by the nut 139 so that a clamping force is generated. The upper surface 120b of the disk medium 120 accommodated on the upper surface 134j of the support portion 134b is pressed by the bending portion 136c of the clamp 136. When the coupling of the nut 139 is completed, the disk medium 120 interposed between the hub 134 and the clamp 136 is firmly clamped.

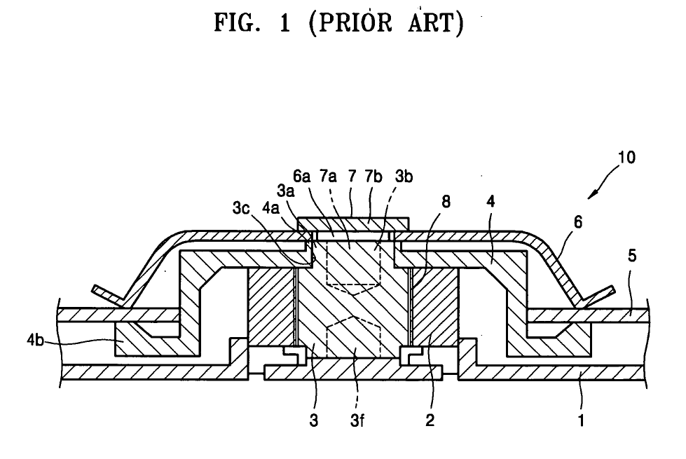

Thus, in the disk driving apparatus 130 consistent with the present invention, since the shaft 133 and the hub 134 are coupled to each other and the clamp 136 is fixed by the nut 139 screw-coupled to the male screw portion 134d formed at the outer circumferential surface of the ceiling plate portion 134e of the hub 134, compared to the conventional disk driving apparatus 10 using the clamping screw 7 shown in FIG. 1, the height H of the disk driving apparatus 130 is decreased while the length of the dynamic bearing portion 138 is maintained. As a result, the disk driving apparatus 130 can be made thin.

Also, in the disk driving apparatus 130 consistent with the present invention, a simple operation of coupling the nut 139 to the hub 134 generates the clamping force to the clamp 136 and fixes the disk medium 120. Since the step portion 134k is formed at the side wall portion 134g of the hub 134, the nut 139 can be prevented from being excessively screwed. Also, since the ceiling plate portion 134e and a part of the side wall portion 134g of the hub 134 are inserted in the circular hole 136a of the clamp 136, the determination on the position of the clamp 136 is easy and assembly accuracy can be easily secured. Accordingly, since the disk medium 120 can be firmly fixed, the disk driving apparatus 130 can stably rotate the disk medium 120.

Furthermore, in the disk driving apparatus 130 according to the present invention, since there is no need to form a small diametric portion in the shaft 133 to couple the conventional clamping screw shown in FIG. 1, the step of processing the shaft 133 can be simplified. Also, since the small diametric portion does not exist in the shaft 133, the length of the dynamic bearing portion 138 can be increased and the stiffness of the disk driving apparatus 130 for rotating the disk medium 120 at a particular speed can be increased.

FIG. 4 is a cross-sectional view of a modified example of the shaft and the hub shown in FIG. 3. Referring to FIG. 4, to couple the shaft 133 and the hub 134, a protruding portion 133h vertically protrudes from the upper surface 133d of the shaft 133 and a forcible insertion hole 134p in which the protruding portion 133h is forcibly inserted is provided in the ceiling plate portion 134e of the hub 134. Alternatively, screw portions 134r and 133j can be formed on an inner circumferential surface of the forcible insertion hole 134p and an outer circumferential surface of the protruding portion 133h, respectively, so that the shaft 133 and the hub 134 can be screw-coupled.

While this invention has been particularly shown and described with reference to exemplary embodiments thereof, it will be understood by those skilled in the art that various changes in form and details may be made therein without departing from the spirit and scope of the invention as defined by the appended claims.

For example, in the above exemplary embodiment, the step portion 134k is described to prevent the excessive screwing of the nut 139. However, the nut 139 can be coupled until the clamp 136 contacts the step portion 134k. In this case, the step portion 134k is used to limit an installation position of the clamp 136. Since the coupling of the nut 139 is needed only for firmly clamping the disk medium 120 by the clamp 136 and the hub 134, the step portion 134k is not necessary.

Also, although, in the above description, the hub 134, the clamp 136, the shaft 133, the bearing sleeve 132 and/or the nut 139 are formed of metal such as stainless steel or aluminum, these elements can be formed of other metal or resin.

Also, although, in the above description, a single unit of the disk medium 120 is installed in the disk driving apparatus 130, the present invention is not limited thereto. For example, a plurality of disk media can be installed. In this case, a spacer for maintaining a gap between the disk media can be disposed therebetween.

Also, although, in the above description, the diameter of the disk medium 120 installed in the disk driving apparatus 130 according to the present invention is not greater than one inch, the present invention is not limited thereto. That is, the disk driving apparatus 130 according to the present invention can be applied to a disk medium having a diameter greater than one inch.

As described above, the present invention has the following effects.

First, since the male screw portion is formed on the outer circumferential surface of the hub and the nut is coupled to the male screw portion, the clamp can be fixed. Accordingly, since the clamping screw and the small diametric portion of the shaft in the conventional technology can be removed and the clamp and nut can be positioned at the almost same height as the height of the hub, or lower than that, the length of the dynamic portion is secured and the disk driving apparatus can be made thin. Also, since the clamp having a ring shape is inserted in the hub and the clamp is pressed and fixed by the coupling of the nut, compared to the conventional fixing unit that fixes the clamp using the clamping screw, the clamp can be fixed with a simple operation and the disk driving apparatus can be easily assembled. Further, the position of the clamp can be easily determined and the accuracy in the coupling of the clamp can be improved. Accordingly, since the clamping force can be surely applied to the disk medium, the disk driving apparatus can stably rotate the disk medium. Since the conventional clamping screw and the small diametric portion of the shaft are no longer needed, in particular, since the step of processing the shaft is not needed, productivity can be improved.

In addition since the step portion is provided at the hub, the coupling position of the nut can be limited and the excessive screwing of the nut can be prevented. Accordingly, the clamp is firmly fixed by a simple operation of coupling the nut at a position where a predetermined clamping force is obtained, so that the disk medium can be firmly clamped.

Furthermore, since the disk driving apparatus according to the present invention is installed in the magnetic disk apparatus, as the height of the disk driving apparatus is lowered, the magnetic disk apparatus can be made thin.

What is claimed is:

1. A disk driving apparatus comprising:
a bearing sleeve having a cylindrical shape;
a shaft rotatably supported in the bearing sleeve;
a hub coupled to the shaft and having a support portion which supports a disk medium outside of the bearing sleeve, said hub further having a male screw portion formed on an outer circumferential surface of an upper end portion thereof;
a clamp having a hole formed at the center thereof, in which the upper end portion of the hub is inserted, and which clamps the disk medium with the support portion of the hub; and
a nut screw-coupled to the male screw portion of the hub and which provides a clamping force of the clamp.

2. The apparatus as claimed in claim 1, wherein the hub comprises a step portion having a diameter greater than that of the male screw portion and formed under the male screw portion.

3. The apparatus as claimed in claim 1, wherein the hub includes a forcible insertion hole, and wherein a protruding portion vertically protrudes from an upper surface of the shaft and is forcibly inserted into the forcible insertion hole.

4. The apparatus as claimed in claim 3, wherein a screw portion is formed on each of an outer circumferential surface of the protruding portion and an inner circumferential surface of the forcible insertion hole, to be coupled with each other.

5. A magnetic disk apparatus including a base and a cover member, a disk medium for storing data, a disk driving apparatus installed on the base and which rotates the disk medium at a particular speed, and an actuator installed on the base to be operative to pivot and move a read/write head to a desired position on the disk medium, the disk driving apparatus comprising:
a bearing sleeve having a cylindrical shape;
a shaft rotatably supported in the bearing sleeve;
a hub coupled to the shaft and having a support portion which supports a disk medium outside of the bearing sleeve, said hub further having a male screw portion formed on an outer circumferential surface of an upper end portion thereof;
a clamp having a hole formed at the center thereof, in which the upper end portion of the hub is inserted, and which clamps the disk medium with the support portion of the hub; and
a nut screw-coupled to the male screw portion of the hub and which provides a clamping force of the clamp.

6. The apparatus as claimed in claim 5, wherein the hub comprises a step portion having a diameter greater than that of the male screw portion and formed under the male screw portion.

7. The apparatus as claimed in claim 5, wherein the hub includes a forcible insertion hole, and wherein a protruding portion vertically protrudes from an upper surface of the shaft and is forcibly inserted into the forcible insertion hole.

8. The apparatus as claimed in claim 7, wherein a screw portion is formed on each of an outer circumferential surface of the protruding portion and an inner circumferential surface of the forcible insertion hole, to be coupled with each other.
